(19) United States
(12) Patent Application Publication
(10) Pub. No.: US 2003/0120582 A1
(43) Pub. Date: Jun. 26, 2003

(54) Call schedule auctioning method and apparatus

(75) Inventors: Jeffrey J. Segal, Greensboro, NC (US); Michael S. Turner, Indianapolis, IN (US)

Correspondence Address: Intellectual Property Group, Bose McKinney & Evans LLP, 2700 First Indiana Plaza, 135 North Pennsylvania Street, Indianapolis, IN, 46204, US

(73) Assignee: OnCall Solutions, Inc.

(21) Appl. No.: 10/027,413

(22) Filed: Dec. 21, 2001

(51) Int. Cl. G06F 17/60

(52) U.S. Cl. 705/37

(57) ABSTRACT

A method, apparatus, and article for auctioning over a communications network are provided. The method includes receiving from a buyer over the communications network a maximum price that the buyer is willing to pay for at least one of a good and a service; receiving from a plurality of potential sellers over the communications network progressively lower competing bids for the at least one of the good or the service, the competing bids corresponding to compensation amounts that potential sellers are willing to accept for providing the at least one of the good and the service; and generating at least one signal corresponding to an identity of a winning seller.

### FIELD OF THE INVENTION

The present invention relates generally to the field of information technology, and, more particularly, to methods, apparatuses, and articles of manufacture for assigning coverage responsibilities for time slots of a call work schedule.

### BACKGROUND

An ethos of the typical medical group is that the doctors should have equal responsibilities. For example, each doctor is expected to share in call duty. “Call” (or “call duty” or being “on call”) is generally understood to mean coverage of the after-hours responsibilities for the entire group. Such responsibilities typically include answering calls from patients and/or working in an emergency room. As much of this duty occurs during the night and on weekends and its intensity tends to be rather unpredictable, call is generally considered to be one of the more onerous aspects of being a physician.

Traditionally, call duty has been rotated among the doctors in the group and care has been taken to ensure that everyone does his or her fair share of weekdays, weekends, and holidays. However, the underlying egalitarian nature of the traditional approach ignores several realities. First, senior physicians have “paid their dues” for many years. They may feel that seniority should have its privileges. To this end, some groups have exempted their most senior physicians from call on weekends and/or holidays and some have even exempted their members from call entirely. Second, senior doctors are more likely to have a busier caseload than junior doctors. Attending to emergencies can be very disruptive to a set schedule. Thus, senior doctors are more likely to view call as a nuisance that interferes with their busy day to day practice activities. Meanwhile, junior physicians are likely to have lower regular case loads. They are often hungrier to build their practices and may welcome the extra duty. Shifting the unscheduled events of call to those having the least appointments can reduce disruptions to the overall practice of the group. Third, junior physicians, fresh from training, are somewhat likely to be more familiar with the latest emergency techniques employed by the major medical centers.

It is a credit to the medical profession that many senior physicians still take call (even if they resent doing it). This sets an inspiring example to the rest of the members of the group. Nonetheless, it is clear that many senior physicians would opt out if the system would still be served. However, any viable alternatives to the traditional approach must still provide some rational bases upon which to determine call duty assignments. Many physicians (junior and senior) would prefer compensation as the arbiter. That is, they would gladly pay others who are capable to assume their call duty.

Additionally, hospitals are responsible for maintaining coverage of their emergency rooms (“ERs”). For example, under the 1986 patient anti-dumping law, also known as the Emergency Medical Treatment and Labor Act (“EMTALA”), all Medicare-participating hospitals with emergency rooms must provide all patients requesting emergency care with an appropriate medical screening to determine if the person has an emergency medical condition. Further, under the EMTALA a hospital is generally obligated to provide emergency coverage of a specialty if it provides similar coverage to its elective patients in the course of day to day business. That is, a hospital is prohibited from providing a certain level of services to elective patients who have the means to pay while denying such coverage to those who come into the emergency room. Such laws are not designed to force hospitals to provide more than they are capable of providing. They are, however, designed to provide a certain degree of fairness for best serving their communities.

The way that many hospitals have provided sufficient ER coverage in the past is to require physicians with admitting privileges to cover an ER call schedule. Traditionally, the quid pro quo has been written into the hospital bylaws. If a physician does elective work at a hospital, the physician will have to cover the ER. Each member is expected to do his/her fair share. In theory, it is an egalitarian system, where each member is treated like everyone else.

However, there are problems with the traditional approach. First, all specialties do not do the same amount or type of ER work. For example, neurosurgeons are frequently called to see patients involved in car accidents at 2:00 AM. Endocrinologists are rarely required to come into the hospital after-hours. The intensity of the work can vary. This same neurosurgeon might be up for six hours trying to save the patient, while other physicians might come to the ER for a few minutes, and then go home. Second, the risks each specialty takes are different based on the type of work they do. Here, “risk” implies exposure to liability of medical malpractice. In general, the risks of ER work done by high risk specialties such as obstetrics/gynecology (“ob-gyn”), neurosurgery, and cardiovascular surgery are much greater than risks incurred by lower risk specialties. Traditionally, these additional risks have not been shared equally among all groups. Third, the pools of physicians available to cover within each specialty can vary significantly. For example, a hospital might have forty internists on staff. This means that call will average less than one night a month. On the other hand, there might only be five orthopedists on staff. Their average call burden would be six nights a month. Fourth, reimbursement issues have not been addressed equally among all groups. Those who are called to see penetrating trauma such as gunshot wounds rarely see any reimbursement for these efforts.

In the 1990's, some trauma centers in the United States found it difficult to obtain adequate coverage for their ERs. Prior to that decade, many physicians were very well paid. They viewed call duty as part of their job description. When reimbursements began to fall, that line of reasoning was rethought. High profile specialties pointed out the “unfair” nature of call schedules. They asked the hospitals to pay them per diem wages for coverage, pay them fee for services performed, and/or to enter into paid consulting agreements under which they would “manage” their specialty for the ER.

Many hospitals resisted initially. They also faced diminishing profit margins and believed that they could not afford to increase the pay of physicians for ER coverage. Coverage became scarce at many facilities. Some physicians refused to come in to see patients. Some ambulances were told to drive past hospitals to find facilities willing to take their patients. Indeed, many hospitals stopped providing emergency care altogether.

Some hospitals were told by specialists that they would refuse to provide ER care unless they were guaranteed payment for providing care. This occurred in southern California. One hospital provided a proposal guaranteeing that physicians would receive 80% of their usual and customary fee. The only specialists included in this deal were those who services were absolutely essential to the day to day running of the ER such as neurosurgery, orthopedics, ob-gyn, general surgery, etc. Not all specialists were included. The specialties with a surplus of practitioners were still asked to provide coverage as a condition of hospital privileges. Other hospitals in the same region were able to provide the same deal to their physicians for guarantees of 70% and 75% of usual and customary fees. Meanwhile, there were some physicians who were excluded from bidding on this process. The number of specialists who were eligible to provide call for the ER was greater than the number who ultimately forced the hospital to the bargaining table. Given the disparity between what one hospital paid versus another, the more generous stipend almost certainly represented an overpayment relative to market value.

Once payment was guaranteed, the slots went from being viewed as onerous to desirable. Indeed, a few physicians controlled who could participate on the call schedule. Many eligible physicians were excluded. It was not uncommon for the controlling physicians to guard their “plums”, keeping others off the schedules. Newcomers would often be assigned to the worst slots, such as weekends and holidays.

Moreover, call duty and the associated problems of working out schedules that provide the requisite coverage while accommodating idiosyncrasies of individuals within the group is not limited to the medical profession.

There is, therefore, a need for methods, apparatuses, and articles of manufacture for call scheduling that facilitate the negotiation of payments by call participants in exchange for assumptions of their call duty.

There is, also, a need for methods, apparatuses, and articles that provide hospitals with a way to bid to find lowest price that they can pay to get coverage. Furthermore, there is a need for a process that is open to all eligible players.

### SUMMARY OF THE INVENTION

The present invention provides a method, apparatus, and article for auctioning over a communications network. The method includes receiving from a buyer over the communications network a maximum price that the buyer is willing to pay for at least one of a good and a service; receiving from a plurality of potential sellers over the communications network progressively lower competing bids for the at least one of the good or the service, the competing bids corresponding to compensation amounts that potential sellers are willing to accept for providing the at least one of the good and the service; and generating at least one signal corresponding to an identity of a winning seller.

The apparatus includes a computing device configured to be coupled to the communications network. The computing device is further configured to receive over the communications network a maximum price that a buyer is willing to pay for at least one of a good or a service; receive over the communications network a plurality of progressively lower competing bids for the at least one of the good or the service, the competing bids corresponding to compensation amounts that potential sellers are willing to accept for providing the at least one of the good or the service; and generate at least one signal corresponding to an identity of a winning seller.

The article includes a computer-readable signal-bearing medium. The computer-readable signal-bearing medium has information signals therein. The information signals correspond to a plurality of instructions which, when executed by the apparatus, cause the apparatus to receive over the communications network a maximum price that a buyer is willing to pay for at least one of a good or a service; receive over the communications network a plurality of progressively lower competing bids for the at least one of the good or the service, the competing bids corresponding to compensation amounts that potential sellers are willing to accept for providing the at least one of the good or the service; and generate at least one signal corresponding to an identity of a winning seller.

The above-noted features and advantages of the present invention, as well as additional features and advantages, will be readily apparent to those skilled in the art upon reference to the following detailed description and the accompanying drawings.

### BRIEF DESCRIPTION OF THE DRAWINGS

FIG. 1 is a block diagram of an exemplary call schedule auctioning system according to the present invention;

FIG. 2 is a flow diagram of an exemplary method of operation according to the present invention;

FIG. 3 is a flow diagram of an exemplary auctioning process for the method of FIG. 2;

FIG. 4 is an illustration of an exemplary group of call schedules;

FIG. 5 is a flow diagram of an alternative exemplary auctioning process according to the present invention; and

FIG. 6 is a flow diagram of another alternative exemplary auctioning process according to the present invention.

### DETAILED DESCRIPTION OF EXEMPLARY EMBODIMENTS

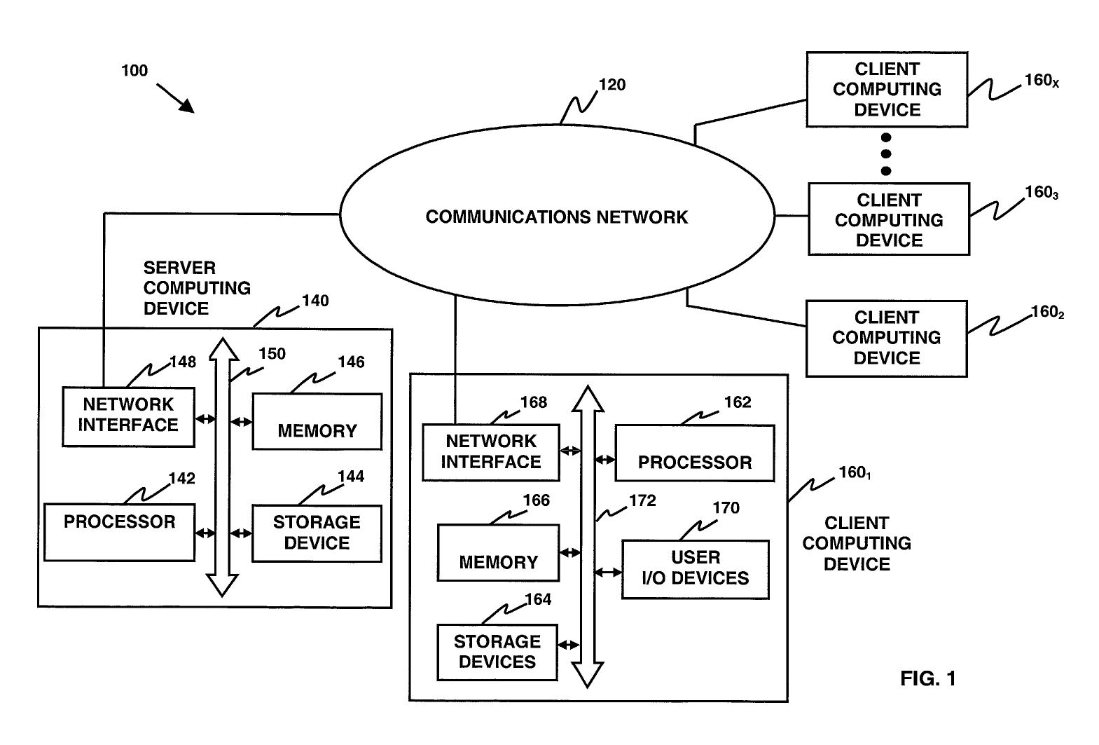

As used throughout this disclosure and the claims, “call” (and/or “call duty” and/or being “on call” and the like) generally means coverage of after-hours responsibilities for a group. Further, “announce” (and/or “announcing” and/or “announcement” and the like) is meant in its broadest sense and includes displaying, printing, articulating with sound, e-mailing, faxing, paging, telephony, and/or any other suitable mode of conveying information to a person. Further, a “user” of the call schedule auctioning system described herein generally means a “worker,” a “customer,” or a “requestor.” In this regard, a worker is a physician, nurse, or any other person who will be assigned to work pursuant to a call duty schedule; while a customer is a designee of a hospital, physician's group, or any other entity that desires to assign one or more workers to call the duty; and a requestor is a worker who wishes to initiate an auction for his or her slot on the schedule as discussed in further detail below. Accordingly, a user may be a worker, a customer, or a requestor, as appropriate, and it should be readily understood that more than one user may access the call schedule auctioning system, each user gaining access via a respective client computing device 160_{X} (see FIG. 1, discussed below). Accordingly, it should be readily appreciated that “call schedule” means is a list, chart, or any other suitable vehicle for announcing time periods during which one or more workers is on call and for storing such information. The “system administrator” of the call schedule auctioning system described herein means the owner, operator, or other custodian of the server computing device 140 (see FIG. 1) who loads the server computing device 140 with the necessary setup information and generally maintains the server computing device 140 and makes it operational and accessible over the communications network 120 (see FIG. 1).

FIG. 1 is a block diagram of an exemplary call schedule auctioning system 100 according to the present invention. The system 100 is configured in a “client/server” (or “two-tier”) architecture. In a typical client/server architecture, each computer or process of a system is viewed as either a “client” or a “server.” Generally, a server manages network resources such as file storage, printing operations, database queries, network communications, etc. To enhance efficiency, various servers may be dedicated to the management of various different resources. For example, a computer that delivers (i.e., “serves up”) Internet web pages is sometimes referred to as a “web server.” A client generally provides a user interface and often provides additional processing power remote from the server. Typically, clients can share files and programs amongst themselves as well as retrieve data from the server(s). Accordingly, the system 100 includes a communications network 120, a server computing device 140, and at least one of a plurality of client computing devices (client computing device 160₁, client computing device 160₂, client computing device 160₃, . . . client computing device 160_{X}). In any event, although the exemplary system 100 is implemented in a client/server architecture, it should be appreciated that alternative embodiments may be implemented in a peer-to-peer architecture or any other suitable configuration.

The communications network 120 operably couples the server computing device 140 to at least one of the plurality of client computing devices 160 such that the server computing device 140 and at least one of the plurality of client computing devices may share information according to the present invention. To this end, the communications network 120 is the Internet, the World Wide Web, and/or any other suitable collection of devices that is connected to share information. It should be readily appreciated that the communications network 120 may include multiple public and/or private Local Area Networks (“LANs”) and/or Wide Area Networks (“WANs”) (not shown) that are operably coupled to one another via routers, switches, hubs, gateways, proxies, and/or firewalls (not shown). Additionally, it is noted that the communications network 120 may include a hardwired telephone network, a wireless telephone network, and/or a satellite network.

In general, the server computing device 140 is implemented with a server computer system or web server manufactured by Dell Computer Corporation of Round Rock, Tex., Gateway, Inc. of San Diego, Calif., or Compaq Computer Corporation of Houston, Tex. Further, the server computing device 140 may alternatively, or in addition, include network server appliances, server farms, server clusters, network accessible storage devices, and/or any other device suitable for executing operations according to the present invention. In the exemplary embodiment of FIG. 1, the server computing device 140 includes a processor 142, a storage device 144, memory 146, a network interface 148, and a system bus 150.

The processor 142 is generally operable to obtain software and/or firmware instructions from the storage device 144, load them into memory 146, and execute the instructions from memory 146. To this end, the processor 142 includes a single x86 processor from Intel or AMD. Alternatively, the processor 142 may include one or more processors utilizing very long instruction words (“VLIW”), code morphing, complex instruction set computer (“CISC”), reduced instruction set computer (“RISC”), single instruction/multiple data (“SIMD”), multiple instruction/multiple data (“MIMD”), or any other suitable architecture; and may be obtained from Compaq, National Semiconductor Corporation, Transmeta Corporation, or any other suitable vendor.

The storage device 144 is generally operable to store data and/or software instructions for the server computing device 140. To this end, the storage device 144 includes a hard disk drive, a floppy disk drive, a CD-ROM drive, a DVD-RAM drive, a RAID device, a Disk-On Chip device, and/or any other suitable computer readable and/or writeable media device. Additionally, the storage device 144 may include multiple media devices and may be distributed among several computing devices such as other servers of a server farm, other database servers, or other network accessible storage (“NAS”) devices. Furthermore, the storage device 144 may store data in a number of different manners such as raw data to the media of the storage device 144, files in a file system of the storage device 144, and/or data, records, or objects in a database of the storage device 144. In the exemplary embodiment, the server computing device 140 transmits and receives information over the Internet according to the HyperText Transfer Protocol (“HTTP”) and the Transmission Control Protocol/ Internet Protocol (“TCP/IP”) network protocol. To this end, the instructions in the storage device 144 include the Internet Information Server available from Microsoft Corporation, the Apache HTTP Server available from the Apache Group, the Zope web application server available from Digital Creations, Inc., or instructions for any other suitable HTTP server or web application server. It is noted, however, that the instructions in the storage device 144 may alternatively include instructions for FTP, TFTP, SMTP, or any other suitable transfer protocol and/or UDP, SMB, NetBUI, or any other suitable network protocol in addition to or instead of instructions for the HTTP protocol and the TCP/IP protocol.

Memory 146 stores data and instructions used by the processor 142. To this end, memory 146 includes standard random access memory for storing the data and software instructions needed by the processor 142. Alternatively, memory 146 may include other volatile memory types such as DRAM, SDRAM, and SRAM for storing data and software instructions and/or non-volatile memory such as ROMs, PROMs, EEPROMs, and flash memory for storing data and firmware instructions.

The network interface 148 operably couples the server computing device 140 to the communications network 120 such that the server computing device 140 may communicate with the at least one of the plurality of client computing devices that are also operably coupled to the communications network 120. To this end, the network interface 148 comprises a network interface controller such as an Ethernet controller or Token Ring controller that connects the server computing device 140 to the communications network 120 via a local area network, firewall, gateway, and/or router. Alternatively, or in addition, the network interface 148 may include an analog modem for use over Plain Old Telephone System (“POTS”) telephone lines such as a 28.8K or 56K modem, a digital modem such as a Cable modem for use over a cable distribution network, an Integrated Services Digital Network (“ISDN”) modem for use over an ISDN telephone line, or a Digital Subscriber Line (“DSL”) modem for use over a DSL telephone line.

The system bus 150 is generally operable to interconnect the processor 142, the storage device 144, memory 146, and the network interface 148, and to enable these components of the server computing device 140 to communicate with one another. To this end, the system bus 150 is implemented with one or more of the PCI, ISA, and VME bus architectures, or any other suitable bus architecture(s). In the exemplary embodiment, the system bus 150 includes a separate address bus and data bus; however, in alternative embodiments, the address bus and data bus need not be separated.

In any event, it is noted that the above described components of the server computing device 140 are merely exemplary, and in alternative embodiments those skilled in the art may elect to replace all or portions of these components with suitable discrete analog circuit components, discrete digital circuit components, integrated analog circuits, integrated digital circuits, and/or integrated analog/digital hybrid circuits without undue experimentation.

As a result of executing the instructions read from memory 146, the processor 142 controls the general operation of the server computing device 140. Further details regarding exemplary operations of the server computing device 140 are discussed below.

Next, those of the plurality of client computing devices included in the system 100 are configured and coupled to the communications network 120 in a like manner to the client computing device 160₁. So, for clarity of exposition, the exemplary embodiment of FIG. 1 is further described below with particular reference to the client computing device 160₁. In general, the client computing device 160₁ is implemented with a personal computer system, a desktop computer system, and/or a workstation manufactured by Dell Computer Corporation of Round Rock, Tex., Gateway, Inc. of San Diego, Calif., and Compaq Computer Corporation of Houston, Tex. Further, the client computing device 160₁ may alternatively, or in addition, include a handheld computer, a laptop computer, a set-top box, a network appliance, a gaming console and/or any other suitable network enabled (preferably Internet enabled) computing device. In the exemplary embodiment, the client computing device 160₁ includes a processor 162, a storage device 164, memory 166, a network interface 168, one or more user I/O devices 170, and a system bus 172.

The processor 162 is generally operable to obtain software and/or firmware instructions from the storage device 164, load them into memory 166, and execute the instructions from memory 166. To this end, the processor 162 includes a single x86 processor from Intel or AMD. Alternatively, the processor 162 may include one or more processors utilizing VLIW, code morphing, CISC, RISC, SIMD, MIMD, or any other suitable architecture; and may be obtained from Compaq, National Semiconductor Corporation, Transmeta Corporation, or any other suitable vendor.

The storage device 164 is generally operable to store data and/or software instructions for the client computing device 160₁. To this end, the storage device 164 may include a hard disk drive, a floppy disk drive, a CD-ROM drive, a DVD-RAM drive, a RAID device, a Disk-On-Chip device and/or other suitable computer readable and/or writeable media device. Additionally, the storage device 164 may include multiple media devices and may be distributed among several computing devices or other network accessible storage NAS devices. Furthermore, the storage device 164 may store data in a number of different manners such as raw data to the media of the storage device 164, files in a filesystem of the storage device 164, and/or data, records, or objects in a database of the storage device 164. In the exemplary embodiment, the client computing device 160₁ transmits and receives the information over the Internet according to the HTTP protocol and the TCP/IP network protocol. To this end, instructions in the storage device 164 include the Internet Explorer web browser, available from Microsoft Corporation of Redmond, Wash.; the Netscape Communicator web browser, available from Netscape Communications Corporation of Mountain View, Calif.; or instructions for any other suitable web browser. Standard web browsers are generally operable to send and receive packets of information that conform to the HTTP and the TCP/IP protocols, send requests for Hyper-Text Markup Language (“HTML”) documents, receive HTML documents, display HTML documents, and send data that a user has input into a HTML form.

Additionally, standard web browsers typically provide mechanisms which enable remote computer systems such as the server computing device 140 to cause the client computing device 160₁ to execute software routines. For example, many web browsers support execution of Java Applets, JavaScript, ActiveX Controls, and other types of software technologies by which the server computing device 140 may cause the client computing device 160₁ to execute software routines in response to information received from the server computing device 140. Also, standard web browsers typically include the ability to determine whether a particular software component such as an ActiveX Control, a plug-in application, or a Java Applet is already installed on the client computing device 160₁ in response to information received from a server computing device 140. Further, standard web browsers typically include the ability to determine the version of such installed software components. Standard web browsers also typically include the ability to download and install a software component such as an ActiveX Control, a plug-in application, or a Java Applet from the server computing device 140 in response to information received from the server computing device 140. Standard web browsers also generally include the ability to cache information received from the server computing device 140 and determine whether the information in the cache is up-to-date with corresponding information of the server computing device 140. In this manner, the web browser of the client computing device 160₁ can prevent the repetitive transfer of the same information from the server computing device 140 to the client computing device 160₁. In other words, if the client computing device 160₁ requests a particular resource from the server computing device 140 and the client computing device 160₁ already has a copy of that resource in the cache, then the web browser can cause the client computing device 160₁ to use the cached version of the resource, thus eliminating a transfer of the resource from the server computing device 140 to the client computing device 160₁.

It is noted, however, that in alternative embodiments, the web browser may not include all of the aforementioned features. Moreover, in alternative embodiments the web browser functions may be implemented as a native custom application of the client computing device 160₁ that is specifically designed for the system 100. The custom application may be implemented to display HTML and other markup language documents in a manner similar to a standard web browser, but need not include all of the features of a standard web browser. Further, in alternative embodiments the custom application may be implemented to receive information from the server computing device 140 in a non-markup language format, and to display the information via a customized graphical interface.

Memory 166 stores data and instructions used by the processor 162. To this end, memory 166 includes standard random access memory for storing the data and software instructions needed by the processor 162. Alternatively, memory 166 may include other volatile memory types such as DRAM, SDRAM, and SRAM for storing data and software instructions and/or non-volatile memory such as ROMs, PROMs, EEPROMs, and flash memory for storing data and firmware instructions.

Additionally, it is noted that the client computing device 160₁ may alternatively be implemented with memory chips and/or other suitable hardware such that the same hardware implements both the storage device 164 and memory 166. Many handheld computing devices (e.g. Palm Pilots), Internet enabled cellular phones, and other special purpose computing devices are implemented in such a manner. It should be readily appreciated that any such device may be used to implement the client computing device 160₁.

The network interface 168 operably couples the client computing device 160₁ to the communications network 120 such that the client computing device 160₁ may communicate with the server computing device 140 via the communications network 120. To this end, the network interface 168 comprises an analog modem for use over POTS telephone lines such as a 28.8K or 56K modem, a digital modem such as a cable modem for use over a cable distribution network, an ISDN modem for use over an ISDN telephone line, or a DSL modem for use over a DSL telephone line. Alternatively, or in addition, the network interface 168 may include a network interface controller such as an Ethernet controller or Token Ring controller that can be used to connect the client computing device 160₁ to the communications network 120 via a local area network, firewall, gateway, and/or router.

The client computing device 160₁ also includes one or more user I/O devices 170. In general, the user I/O devices 170 provide a user of the client computing device 160₁ with mechanisms for entering information into the client computing device 160₁, receiving information from the client computing device 160₁, and/or controlling the operation of the client computing device 160₁. To this end, the user I/O devices 170 may include cathode ray tubes (“CRT”), liquid crystal displays (“LCDs”), light emitting diodes (“LEDs”), printers, and/or other output devices that are operable to visually present information to a user of the exemplary client computing device 160₁. The user I/O devices 170 may also include sound cards, wave generators, sequencers, mixers, speakers, and/or other audio devices that are used to audibly present information to a user of the exemplary client computing device 160₁. Further, the user I/O devices 170 may include a mouse, a keyboard, a touch pad, a push button, a scanner, a stylus, a touch screen, a diskette drive, a compact disc read-only-memory (“CDROM”) drive, and/or other input devices that provide a user of the exemplary client computing device 160₁ with an interface to directly control the operation of the client computing device 160₁ and/or indirectly control the operation of the server computing device 140. In the exemplary embodiment, the user I/O devices 170 are operable to display HTML documents and HTML forms. However, in alternative embodiments the user I/O devices 170 may display documents in SGML, XML, Tex, LaTeX and/or other suitable markup language formats.

The system bus 172 is generally operable to enable the various components of the client computing device 160₁ to communicate with one another. To this end, the system bus 172 may be implemented with one or more of the PCI, ISA, and VME architectures, or any other suitable bus architecture(s). In the exemplary embodiment, the system bus 172 includes bus lines and/or traces which interconnect the processor 162, the storage device 164, memory 166, the network interface 168, and the user I/O devices 170.

In any event, it is noted that the above described components of the client computing device 160₁ are merely exemplary, and in alternative embodiments those skilled in the art may elect to replace all or portions of these components with suitable discrete analog circuit components, discrete digital circuit components, integrated analog circuits, integrated digital circuits, and/or integrated analog/digital hybrid circuits without undue experimentation.

As a result of executing the instructions read from memory 166, the processor 162 controls the general operation of the client computing device 160₁. Further details regarding exemplary operations of the client computing device 160₁ are discussed below.

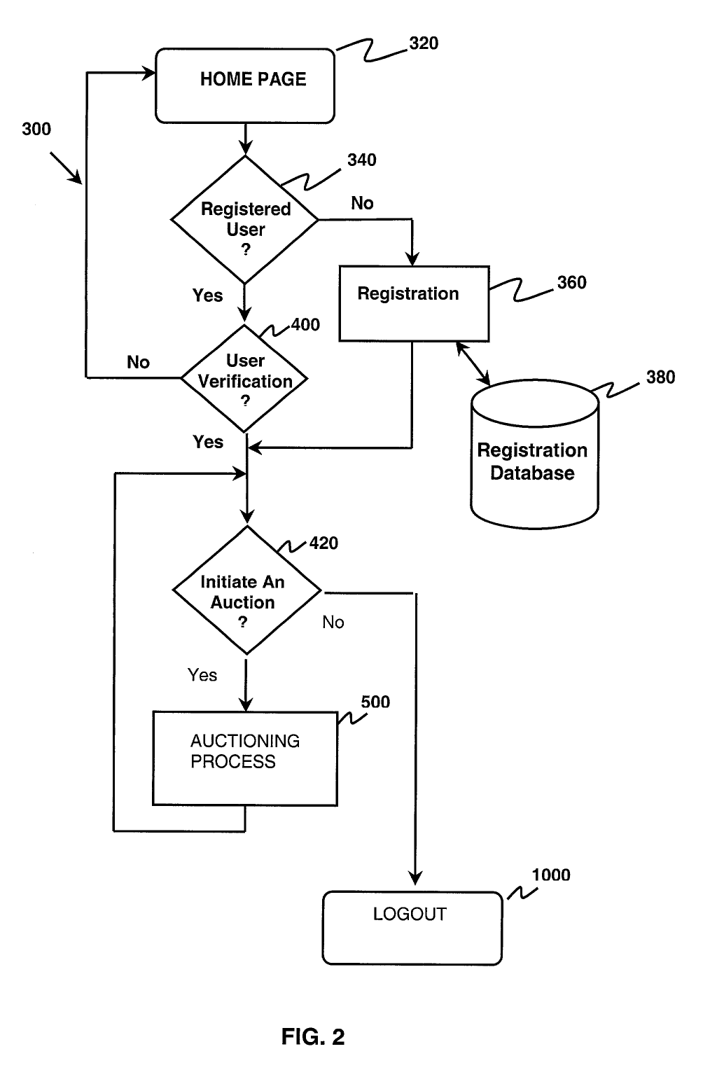

FIG. 2 is a flow diagram of an exemplary method of operation 300 according to the present invention. For clarity of exposition, the method of operation 300 is described below with reference to an exemplary embodiment of the system 100 (see FIG. 1) in which the communications network 120 is the Internet. Further, as noted above, those of the plurality of client computing devices included in the system 100 are configured and coupled to the communications network 120 in a like manner to the client computing device 160₁. So, for clarity of exposition, where applicable the method of operation 300 is described below with references to the client computing device 160₁. Accordingly, it should be readily appreciated that references to the client computing device 160₁ and/or the client computing device(s) 160₁ in the following description and the claims are not limited to the operations of a single client computing device 160₁, but instead are intended to cover the operations of one and/or more than one of the client computing devices of the system 100.

At step 320, a user accesses an Internet home page via the user I/O devices 170 of the client computing device 160₁ (see FIG. 1, discussed above). To this end, the user directs the client computing device 160₁ to initiate communications with the server computing device 140 by inputting the Internet address, or Uniform Resource Locator (“URL”), for the server computing device 140 into a web browser that runs on the client computing device 160₁ or by any other suitable manner. The home page display is similar in form and function to a typical Internet website home page. Accordingly, the client computing device 160₁ displays welcoming messages to the user and displays a general description of the services provided by the present invention. In alternative embodiments, the Home Page operations may also suitably display commercial advertisements and/or otherwise provide advertising space that may be sold or leased to generate revenue for the system administrator. After step 320 operations, the system 100 proceeds to step 340.

At step 340, the system 100 (through the user I/O devices 170 of the client computing device 160₁) announces a query asking the user whether the user is a “registered user” of the present invention. A “registered user” is a user who has previously entered the requested “registration information” (discussed in more detail below). It should be readily appreciated that restricting access to the present invention to registered users may provide a source of revenue for the of system administrator in the form of one time registration fees and/or periodic subscription fees. In any event, if the user indicates that the user is a registered user, then the system 100 skips to step 400 (discussed further below); else, the system 100 proceeds to step 360.

At step 360, the system 100 executes “Registration” operations. Here, the system 100 (through the user I/O devices 170 of the client computing device 160₁) prompts the user to enter “registration information.” In response, the user enters registration information in the form of an alphanumeric user identification name (“User ID”) and security code (or “password”), both of the user's arbitrary choosing. The client computing device 160₁ transmits the User ID and password to the server computing device 140 via the communications network 120. In connection with the Registration operations, the server computing device 140 maintains a registration database (shown as step 380 operations). The server computing device 140 checks the contents of its registration database to ensure that the user's registration information does not conflict with (i.e., is not the same as) any previously stored registration information. If the server computing device 140 detects a conflict, then the server computing device 140 notifies the client computing device 160₁, which in turn notifies the user and prompts the user for non-conflicting registration information through the user I/O devices 170. The system 100 repeats the prompts for registration information, receipts of registration information, and conflicts checks until the user enters non-conflicting registration information. When non-conflicting registration information is received, the server computing device 140 saves the User ID and password as associated data in the registration database (step 380 operations). After step 360 operations (and step 380 operations), the system 100 skips to step 420 (discussed further below).

At step 400, the system 100 executes “User Verification” operations. Here, the client computing device 160₁ (through the user I/O devices 170) prompts the user for the user's User ID and password, which should have been received from the user during a previous registration session (see step 360 operations, discussed above). The client computing device 160₁ receives the User ID and password and transmits them to the server computing device 140 via the communications network 120. The server computing device 140 determines whether the User ID and password are valid (i.e., whether the User ID and password have been previously stored and associated with each other in the registration database). After the server computing device 140 determines that the User ID and password are valid (or “verified”), then the system 100 proceeds to step 420; else the system 100 loops back to Home Page operations (see step 320, discussed above).

At step 420, the system 100 (through the user I/O devices 170 of the client computing device 160₁) announces a query asking the user whether the user wishes to initiate an auctioning process according to the present invention as discussed in further detail below. Via the user I/O devices 170, the user responds in either the affirmative (i.e., yes) or the negative (i.e., no). If the user responds in the negative, then the system 100 skips to step 1000 operations, where the system 100 logs the user out in a manner which is well known. On the other hand, if the user responds in the affirmative then the system 100 proceeds to the auctioning process 500 (discussed in further detail below).

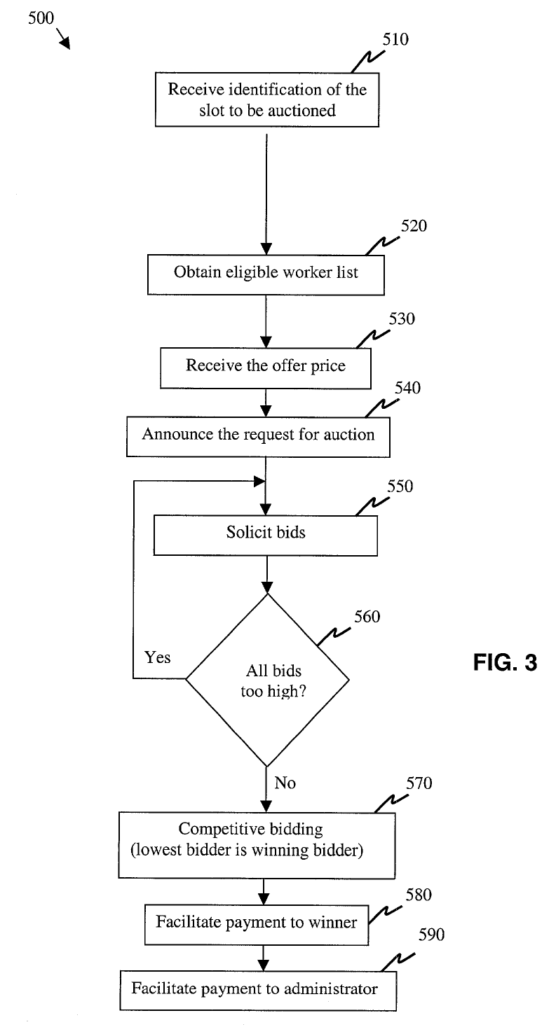

FIG. 3 is a flow diagram of an exemplary auctioning process 500 for the method of FIG. 2. At step 510, either a requestor who wishes to auction off at least one of his or her call duty assignments or “slots” from a predetermined call schedule or a customer who wishes to auction off at least one as yet unassigned or “blank slot” to fill a predetermined call schedule enters (through the user I/O devices 170 of the client computing device 160₁) an identification of the relevant call duty slot into the system 100. It is noted that prior to the initiation of the auctioning process 500, the predetermined call schedule may have been suitably created and stored in the storage device 144 of the server computing device 140 or stored in a remote memory device that is accessible by the server computing device 140 over the communications network 120.

Software such as the Physician Scheduler®, which is available from MSI Software, Inc. (a company located at 13800 Coppermine Road, Suite 112, Herndon, Va. 20171; see http://www.msisoftware.com), and other suitable scheduling software is widely available. Such applications may involve the customer inputting customer demographic information into the system 100 through the user I/O devices 170 of the client computing device 160₁. The customer demographic information may suitably include indications of the time slots that need to be covered (e.g., the days of the week, hours of the day, number of weeks or months, etc.), the location of the facilit(ies) where the call duty is to be performed, the size of the facilit(ies) (e.g., the number of beds in a hospital and/or the hospital's ER), the focus(es) or specialties of the facilit(ies) (e.g., “womens' hospital,” “childrens' hospital,” “teaching hospital,” “cardiac center,” etc.), and/or any other suitable information regarding the facilit(ies) or the nature of the call duty. Further, in some applications the customer may input intra-schedule (within a particular one schedule) and/or inter-schedule (between a group of schedules) constraints or “rules” for a one or more schedules and/or one or more groups of schedules, respectively. For example, one intra-schedule rule might be that a particular schedule may not show a particular physician to be on call on Tuesdays, while one inter-schedule rule might be that three particular schedules may not show a particular physician to be on call for more than a total of 18 hours in any 24 hour period.

To facilitate operations of the system 100, the server computing device 140 may retrieve the call schedule from a remote memory by a field-to-field data transfer and then send it to the client computing device 160₁ over the communications network 120 for display through the user I/O devices 170 of the client computing device 160₁ in any number of ways which are well known. However, it should be appreciated that neither the manner in which the call schedule is generated nor access to the schedule per se is essential to the present invention. The identification of the slot may be in whatever form that suitably communicates to other workers who may be interested in taking the call duty of the particular assignment that is being auctioned.

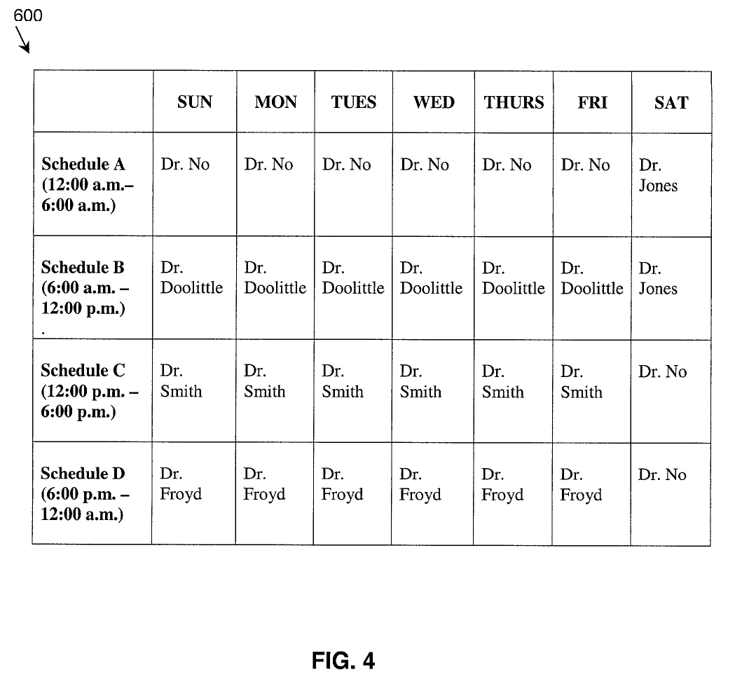

For example, FIG. 4 is an illustration of an exemplary group of call schedules 600. It is noted that the group 600 is merely exemplary, and various suitable alternative ways of announcing call duty information, either alone or in combination with other information, are well known. The group 600 includes weekly Schedule A (for the 12:00 a.m.-6:00 a.m. time period), weekly Schedule B (for the 6:00 a.m.-12:00 p.m. time period), weekly Schedule C (for the 12:00 p.m.-6:00 p.m. time period), and weekly Schedule D (for the 6:00 p.m.-12:00 a.m. time period). It should be readily appreciated that group 600 may suitably represent a call duty schedule for a hospital emergency room, for an OBGYN practice, or any other typical area of responsibility. Assuming for the sake of example that group 600 is an ER call schedule for Methodist Hospital in Indianapolis, Ind. and Dr. No would like to take his wife to a performance of the Indianapolis Symphony Orchestra on Saturday night without having to worry about being called into work, after logging into the system 100 and initiating the auction process 500 as discussed above, Dr. No. enters “Methodist/Indianapolis/ER/Schedule D/Saturday,” “Methodist/Indianapolis/ER/Saturday/6 to midnight,” or any other information which suitably identifies the slot to be auctioned. After receiving the identification of the slot, the system 100 proceeds to step 520 operations.

At step 520, the server computing device 140 obtains a list of workers who are eligible to participate in the auction. The server computing device 140 may obtain the list from the registration database (i.e., assume that all registered users are eligible to participate), it may obtain the list via a field-to-field data transfer from a remote memory pursuant to a communication over the communications network 120, or it may obtain or generate the list in any other suitable manner. Here, it should be noted that eligibility to participate in the auction does not necessarily equate to eligibility to work the call duty that is being auctioned. In general, a worker is eligible to work the call duty if doing so would fit the demographics of the duty without violating any of the rules for the relevant schedule.

The concept of eligibility to work (or lack thereof) can be illustrated by the following negative example: If the indicated slot requires an anesthesiologist to be on call for an ER from 8 PM until midnight, but meanwhile one intra-schedule rule is that Dr. Smith cannot be on call on Sundays and an inter-schedule rule is that no group of schedules may show Dr. Smith to be on call for more than 12 hours in any 24 hour period, then Dr. Smith would not be eligible 1.) if Dr. Smith is a surgeon (i.e., he is not an anesthesiologist), 2.) if the indicated slot falls on a Sunday, or 3.) if the indicated slot falls on a Tuesday but Dr. Smith is already scheduled for six hours of call for an operating room of a first hospital located on the east side of town from 6 AM until noon on that Tuesday and he is scheduled for another four hours of call for an operating room of a second hospital located on the west side of town from 3 PM until 7 PM on the same day.

Further, depending on the demographics and/or rules, the workers who are actually eligible to work may suitably be limited to workers from a specific group (such as the physicians of a particular medical practice or office) or it may suitably include workers from outside the group. Including workers from outside the group may effectively remove the agent or middle man from the historical “locum tenens” or temp agency arrangement. Locum tenens is a process for temporarily placing a doctor short-term within a practice or a community. It fills in a gap for coverage for a single doctor's office, a group, a hospital, or a community. To this end, locum tenens is generally understood to be a temporary situation, though the term of the employment might last from days to weeks and it is typically possible for a locum tenens doctor to eventually accept permanent position.

After a need is identified a hospital or group will typically contact an agency that hires locum tenens physicians. The agency knows of doctors who are looking for part-time work. Such agencies are middlemen who are responsible for verifying that the temporary doctors are licensed in the appropriate state, for making sure that they have appropriate malpractice coverage, and for ensuring that the doctors are credentialed. Credentialing means the completion of appropriate due diligence has been performed verifying that the doctors graduated from accredited medical schools and post-graduate programs and have not been disciplined. Unfortunately, a doctor is typically represented by only one agency. This limits the opportunities for that particular doctor. In addition, a group or hospital typically picks one agency to fill an opening. This limits the opportunities for that particular group or hospital. Consequently, such agencies traditionally have had the market power to command large fees for their services. The following scenarios illustrate a few exemplary applications of the locum tenens concept:

### Scenario No. 1

Assume that an anesthesia group of 8 doctors is very busy. One of the doctors becomes disabled. The group is now working at maximum capacity. To provide adequate service to the surgeons, the anesthesiologists are unable to take vacations. They plan to hire another MD, but recognize that it is September and residents do not graduate until the end of June the next year. So, they use a locum tenens service to fill this position until they can make a permanent hire.

### Scenario No. 2

Assume that an ob-gyn doctor in a small town is the only specialist of that type within a radius of 50 miles. This doctor wants to take a two week vacation. He wants someone to cover his practice while he is away. Also, the community wants coverage in case a baby needs to be delivered. Here, the hospital (community) and the doctor both want cross coverage. Locum tenens is used to fill that slot for two weeks.

### Scenario No. 3

Assume that a radiology group at a hospital becomes frustrated with bad terms of a contract with a hospital. They walk out en-masse. The hospital administration wants to bring in another group, but recognizes that this solution will take time. In the meantime, the community must be served. The hospital uses locum tenens to fill the gap.

It should be appreciated that the present invention may suitably eliminate the middlemen. This allows doctors to shop around for better jobs and, logically, to be paid a bit higher as a consequence. It also allows groups or hospitals to get a better deal because they will be exposed to a better selection and, logically, a better price. Nevertheless, it is noted that users of the present invention may manually determine and manage eligibilities to work and thus, doing so automatically is not critical to the present invention.

At step 530, the requester or the customer enters an offer price into the system 100 via the user I/O devices 170 of the client computing device 160₁. The offer price indicates a maximum amount of compensation that the requester or the customer is willing to pay a worker for taking the slotted call duty. The compensation may be a fixed dollar amount (e.g., $100.00) or a relative dollar amount (e.g., 150% of a worker's reasonable and customary hourly rate). After step 530 operations, operation of the system 100 proceeds to step 540.

At step 540, the system 100 announces to the workers eligible to participate in the auction that the requester or customer wishes to pay any one of these workers to take coverage responsibility for the identified slot. It should be appreciated that the announcement may be suitably made via the user I/O devices 170 of the client computing device 160₁ (in response to a communication from the server computing device 140 over the communications network 120) or by any other suitable manner. In any event, the announcement includes indications of the date and time of the slot and may include indications of suitable demographic information about the call duty. After step 540 operations, the system 100 proceeds to step 550.

At step 550, the system 100 “solicits” bids, or announces a request for bids via the user I/O devices 170. Workers eligible to participate in the auction may enter their bids for the identified slot into the system 100 via the user I/O devices 170 of their respective client computing device 160₁. Each bid includes a minimum amount of compensation that the bidding worker will accept in return for assuming the identified call duty. Like the maximum amount of compensation offered by the requester or the customer, the minimum amount of compensation may be a fixed dollar amount or a relative amount.

Additionally, bids may suitably include “bid schedules.” A bid schedule specifies an initial or opening bid, a relatively lower final or bottom bid, and a schedule or framework for lowering the worker's present or active bid (i.e., the worker's bid “in play”) from the opening bid towards the worker's bottom bid. For example, a worker may prefer to be paid $500 to take the call slot that is up for bids, but may be willing to take as little as $100. Here, it should be appreciated that the compensation for taking the slot would likely be in addition to compensation paid by the hospital or other facility in which the services are rendered in the event that the worker is actually called into work. So, some flexibility in the worker's price for merely assuming the chance of being called into work would not be unusual. In any event, to continue the example, a bid schedule for the worker could include an indication that the worker's opening bid for the slot is to be $500, an indication that the lowest amount of compensation that the worker will accept is $100, and a schedule for lowering the bid over time until the auction for the slot has ended. The schedule might indicate, for example, that the worker's bid in play is to be replaced by a new bid that is $50 lower than the worker's prior bid on each day that the auction progresses until the bid has been lowered to $100. Accordingly, the server computing device 140 automatically lowers the worker's bid in increments when: (a) the worker's current bid is higher than the maximum amount of compensation that the requester is willing to pay, or (b) a competing bid by another worker is lower than the worker's current bid. After step 550 operations, operation of the system 100 proceeds to step 560.

At step 560, the server computing device 140 determines whether all of the bids received from the bidding workers are higher than the maximum amount of compensation offered by the requester. If all of the bids are higher than the maximum amount of compensation, then the server computing device 140 transmits an indication of this, along with a solicitation for lower bids, to the client computing device 160₁ over the communications network 120. The client computing device 160₁ in turn announces (via the user I/O devices 170) to the workers who are eligible to participate in the auction that all of the bids received so far are higher than the maximum amount of compensation offered by the requestor and announces a request for lower bids(via the user I/O devices 170) to the workers who are eligible to participate in the auction. Then, operations of the system 100 loop back to step 550. On the other hand, if any of the bids are lower than the maximum amount of compensation offered by the requester, then the system 100 proceeds to step 570.

At step 570, eligible workers participate in a competitive bidding process that is managed by the system 100. Here, the system 100 announces (via the user I/O devices 170) the lowest price that is presently bid for taking the identified slot. Further, the competitive bidding process may suitably include the system 100 announcing a “bid history” such as, for example, a listing of the last five lowest bids. However, it is noted that in alternative embodiments the system 100 may not announce a bid history, thereby effectively hiding the competing bids from the workers. In any event, the system 100 receives (via the user I/O devices 170) competing bids from the eligible workers until the expiration of a time period specified by the request or or customer who has initiated the auction via the user I/O devices 170, or from a system default setting.

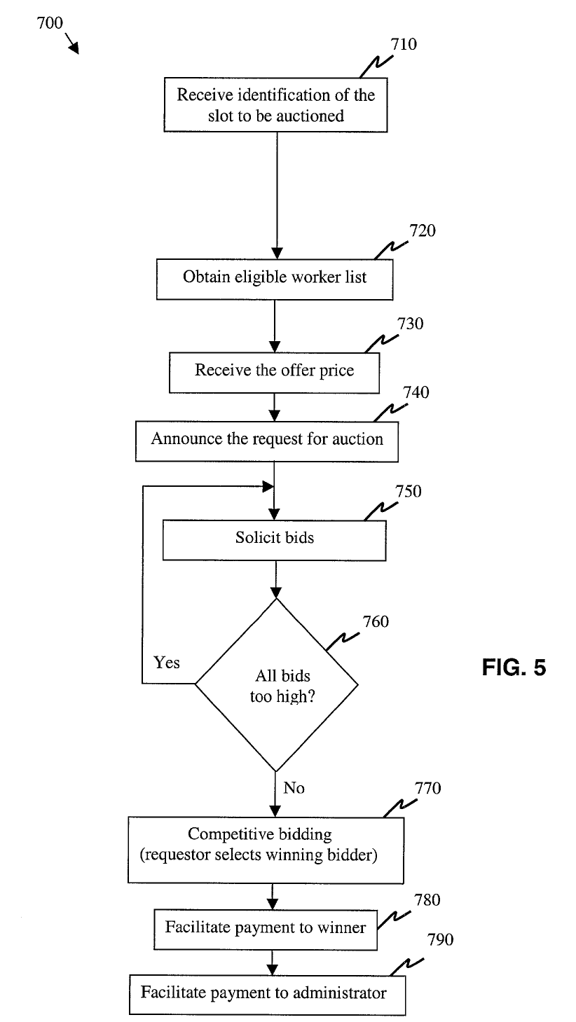

Upon expiration of the time period, in some embodiments the system 100 deems the lowest bidding worker the “winning bidder” (or “winner”) of the auction. The winning bidder is the worker who will be expected to assume the call duty. However, it should be appreciated that for a number of personal and/or professional reasons, the request or may wish to select someone other than the lowest bidder as the one who will take the call duty. So, in alternative embodiments the system 100 receives the requestor's designation or selection of the winning bidder from the request or via the user I/O devices 170 (see FIG. 5). In any event, the server computing device 140 generates a signal(s) corresponding to the identity of the winning bidder and transmits the signal(s) to the client computing device(s) 160₁ of the eligible workers over the communications network 120. In turn, the client computing device(s) 160₁ of the eligible workers generate an announcement(s) of the identity of the winning bidder via the respective user I/O devices 170. After step 570 operations, the system 100 proceeds to step 580.

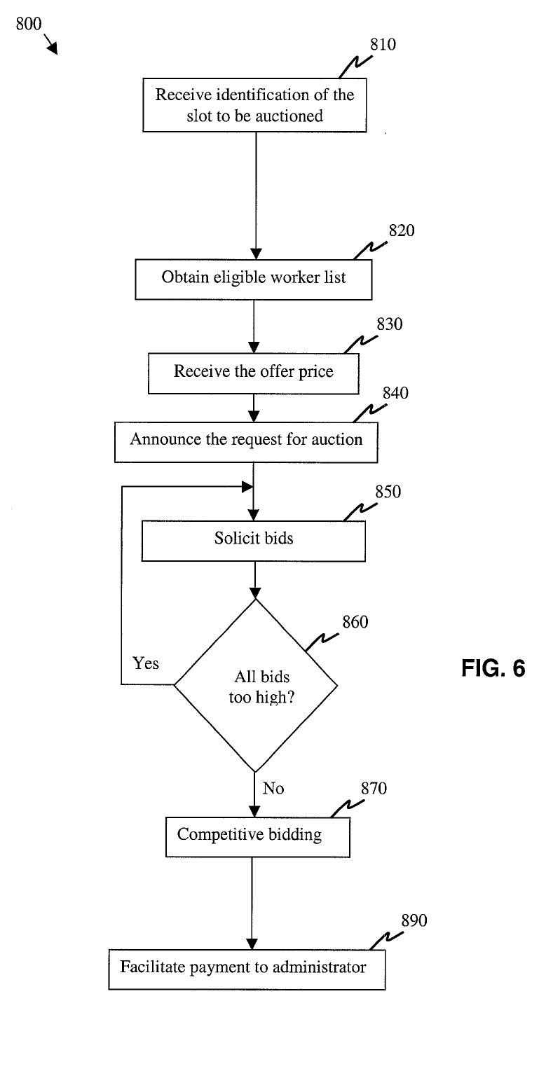

At step 580, the request or or the customer who initiated the auction pays the winning bidder pursuant to that worker's bid. The system 100 facilitates the requestor's or the customer's payment by receiving credit card information and/or other bank account information from the requester or the customer and the winner via their respective user I/O devices 170 and then effectuating a suitable electronic funds transfer(s). Further, facilitating the payment may include the system 100 receiving information from the requester (via the user I/O devices 170) for setting up an electronic account into which the requestor may electronically deposit funds as well as from which the requester may make the necessary payments, and may further include the system 100 carrying (or storing) a balance on behalf of the requester in memory 146 of the server computing device 140. It is noted, however, that step 580 operations may suitably be omitted from some embodiments of the present invention, in which cases the requester or the customer must make independent arrangements for paying the winner (see FIG. 6). After step 580 operations, operation of the system 100 proceeds to step 590.

At step 590, the requestor or the customer who initiated the auction pays a transaction fee to the system administrator. It should be appreciated that the transaction fee generates revenue for the system administrator. The server computing device 140 may facilitate the payment of the transaction fee by calculating the fee as a percentage of the compensation paid by the requester or the customer to the winning worker (i.e., a percentage transaction fee) or, alternatively, by setting the transaction fee based on a flat or fixed fee per each auction (i.e., a fixed transaction fee) or based on a flat fee for access rights to the system 100 (e.g., a monthly subscription fee). In any event, the system 100 may effectuate payment of the transaction fee by the requestor or the customer, by the winning bidder, or by any other user or users of the system 100. Additionally, it should be appreciated that the present invention may provide other revenue facilities to the system administrator such as, for example, by providing a platform(s) (via the user I/O devices 170) for announcements of commercial advertisements and/or advertising time/space that may be sold or leased for profit.

FIG. 5 is a flow diagram of an alternative exemplary auctioning process 700 according to the present invention. In the exemplary embodiment of FIG. 5, steps 710-760 and 780-790 are identical to steps 510-560 and 580-590, respectively, of the exemplary auctioning process 500 discussed above. However, step 770 differs from step 570 in that in step 770 the requester or customer who initiated the auction designates the winning bidder via the user I/O devices 170 (see step 570, discussed above).

FIG. 6 is a flow diagram of an alternative exemplary auctioning process 800 according to the present invention. In the exemplary embodiment of FIG. 6, steps 810-870 and 890 are identical to steps 510-570 and 590, respectively, of the exemplary auctioning process 500 discussed above. However, it should be readily appreciated that auctioning process 800 differs from auctioning process 500 by the omission of payment to the winner. In auctioning process 800, the requestor or customer who initiates the auction must make independent arrangements to pay the winning bidder for taking the identified slot.

The foregoing description of the invention is illustrative only, and is not intended to limit the scope of the invention to the precise terms set forth. Accordingly, it is noted that many of the features of the present invention may suitably be used to auction any suitable good(s) and/or service(s). Further, although the invention has been described in detail with reference to certain illustrative embodiments, variations and modifications exist within the scope and spirit of the invention as described and defined in the following claims.

What is claimed is:

1. A method for auctioning over a communications network, the method comprising the steps of:
receiving from a buyer over the communications network a maximum price that the buyer is willing to pay for at least one of a good and a service;
receiving from a plurality of potential sellers over the communications network progressively lower competing bids for the at least one of the good or the service, the competing bids corresponding to compensation amounts that potential sellers are willing to accept for providing the at least one of the good and the service; and
generating at least one signal corresponding to an identity of a winning seller.

2. The method of claim 1, further comprising the steps of:
notifying eligible workers over the communications network of an auction of a call schedule assignment;
wherein the step of receiving the bids includes
receiving over the communications network at least one bid for the call schedule assignment from at least one of the workers;
notifying the workers over the communications network that a lower bid is needed if each of the bids is higher than a maximum amount; and
receiving over the communications network competing bids for the call schedule assignment from a plurality of eligible workers until a time period has expired.

3. The method of claim 2, further comprising the step of hiding the competing bids from the workers.

4. The method of claim 2, further comprising the step of automatically lowering at least one of the competing bids.

5. The method of claim 4, further comprising the step of hiding the competing bids from the workers.

6. An apparatus for auctioning over a communications network, the apparatus comprising:
a computing device configured to be coupled to the communications network, the computing device being further configured to
receive over the communications network a maximum price that a buyer is willing to pay for at least one of a good or a service,
receive over the communications network a plurality of progressively lower competing bids for the at least one of the good or the service, the competing bids corresponding to compensation amounts that potential sellers are willing to accept for providing the at least one of the good or the service, and
generate at least one signal corresponding to an identity of a winning seller.

7. The apparatus of claim 6, wherein the computing device is further configured to
obtain a list of eligible workers, and
transmit over the communications network a notification of an auction of a call schedule assignment, and
wherein being configured to receive the bids includes being configured to
receive over the communications network at least one bid for the call schedule assignment,
transmit over the communications network a notification that a lower bid is needed if each of the bids is higher than a maximum amount; and
receive over the communications network competing bids for the assignment from at least some of the eligible workers on the until a time period has expired.

8. The apparatus of claim 7, wherein the computing device is further configured to hide the competing bids from the workers.

9. The apparatus of claim 7, wherein the computing device is further configured to automatically lower at least one of the competing bids.

10. The apparatus of claim 9, wherein the computing device is further configured to hide the competing bids from the workers.

11. An apparatus for auctioning an assignment on a call work schedule, the schedule being suited for communication over a communications network, the apparatus comprising:
a computing device configured to be coupled to the communications network, the computing device being further configured to
transmit a request over the communications network to auction the assignment,
obtain a list of workers who can take the assignment without violating at least one of demographic information and rules,
transmit at least one bid for the assignment over the communications network, and
generate an announcement corresponding to an identity of a winning bidder.

12. An article of manufacture for auctioning over a communications network, the article of manufacture comprising:
a computer-readable signal-bearing medium, the computer-readable signal-bearing medium having information signals therein, the information signals corresponding to a plurality of instructions which, when executed by the apparatus, cause the apparatus to
receive over the communications network a maximum price that a buyer is willing to pay for at least one of a good or a service,
receive over the communications network a plurality of progressively lower competing bids for the at least one of the good or the service, the competing bids corresponding to compensation amounts that potential sellers are willing to accept for providing the at least one of the good or the service, and
generate at least one signal corresponding to an identity of a winning seller.

13. The article of claim 12, wherein the plurality of instructions, when executed by the apparatus, further cause the apparatus to
obtain a list of eligible workers,
transmit over the communications network a notification of an auction of a call schedule assignment,
receive over the communications network at least one bid for the assignment,
transmit over the communications network a notification that a lower bid is needed if each of the bids is higher than a maximum amount, and
receive over the communications network competing bids for the assignment from at least some of the workers until a time period has expired.

14. The article of claim 13, wherein the plurality of instructions, when executed by the apparatus, further cause the apparatus to hide the competing bids from the workers.

15. The article of claim 13, wherein the computer-readable signal-bearing medium includes a recordable data storage medium.

16. The article of claim 15, wherein the plurality of instructions, when executed by the apparatus, further cause the apparatus to hide the competing bids from the plurality of workers.

17. The article of claim 13, wherein the computer-readable signal-bearing medium is selected from a group consisting of magnetic, optical, biological, and atomic data storage media.

18. The article of claim 17, wherein the plurality of instructions, when executed by the apparatus, further cause the apparatus to hide the competing bids from the workers.

19. The article of claim 13, wherein the computer-readable signal-bearing medium includes a modulated carrier signal.

20. The article of claim 19, wherein the plurality of instructions, when executed by the apparatus, further cause the apparatus to hide the competing bids from the workers.

21. The article of claim 13, wherein the plurality of instructions, when executed by the apparatus, further cause the apparatus to automatically lower at least one of the competing bids.

22. The article of claim 21, wherein the plurality of instructions, when executed by the apparatus, further cause the apparatus to hide the competing bids from the workers.
